(19) United States
(12) Patent Application Publication
(10) Pub. No.: US 2023/0075000 A1
(43) Pub. Date: Mar. 9, 2023

(54) OBJECT RECOGNITION DEVICE

(71) Applicant: DENSO CORPORATION, Kariya-city (JP)

(72) Inventor: Takashi OGAWA, Kariya-city (JP)

(21) Appl. No.: 18/050,323

(22) Filed: Oct. 27, 2022

Related U.S. Application Data
(63) Continuation of application No. PCT/JP2021/016021, filed on Apr. 20, 2021.

(30) Foreign Application Priority Data
Apr. 30, 2020 (JP) 2020-080182

(51) Int. Cl. G01S 7/497; G01S 17/931

(52) U.S. Cl. CPC G01S 7/497; G01S 17/931

(57) ABSTRACT

An object recognition device includes a detection point acquisition unit that acquires detection points in a plurality of orientations by using a sensor and an object recognition unit that recognizes an object by using at least some of the detection points. The object recognition device includes an exclusion unit. The exclusion unit excludes the detection point that does not satisfy a stereoscopic point condition, the detection point the detection point number of which is a threshold value or smaller, and the detection point the discontinuity index of which is a threshold value or higher, from the detection points acquired by the detection point acquisition unit. The object recognition unit recognizes the object by using the detection point that is acquired by the detection point number calculation unit and has not been excluded by the exclusion unit.

### CROSS-REFERENCE TO RELATED APPLICATION

The present application is based on and claims the benefit of priority from earlier Japanese Patent Application No. 2020-80182 filed Apr. 30, 2020, the description of which is incorporated herein by reference.

### BACKGROUND

### Technical Field

The present disclosure relates to an object recognition device.

### Related Art

An object recognition device recognizes an object by using a laser radar or the like.

### SUMMARY

An aspect of the present disclosure is an object recognition device including: a detection point acquisition unit configured to acquire detection points in a plurality of orientations by using a sensor; and an object recognition unit configured to recognize an object by using at least some of the detection points acquired by the detection point acquisition unit.

The object recognition device, which is an aspect of the present disclosure, includes a stereoscopic point determination unit configured to determine whether each of the plurality of detection points satisfies a stereoscopic point condition defined below; a detection point number calculation unit configured to calculate a detection point number defined below for each of the plurality of detection points; a discontinuity index calculation unit configured to calculate a discontinuity index that becomes higher as the number of missing detection points defined below increases, for each of the plurality of detection points; and an exclusion unit configured to exclude the detection point that does not satisfy the stereoscopic point condition, the detection point the detection point number of which is a threshold value or smaller, and the detection point the discontinuity index of which is a threshold value or higher, from the detection points acquired by the detection point acquisition unit.

The object recognition unit is configured to recognize the object by using the detection point that is acquired by the detection point number calculation unit and has not been excluded by the exclusion unit.

The stereoscopic point condition: another detection point having a different height is present in a predetermined region including the detection point for which whether to satisfy the stereoscopic point condition is determined.

The detection point number: the number of the detection points present in a predetermined region including the detection point for which the detection point number is calculated.

The missing detection point: the detection point present in the orientation between the orientation of a first detection point and the orientation of a second detection point and outside a predetermined reference region, the first and second detection points being any two of the detection points present in the reference region including the detection point for which the discontinuity index is calculated.

### BRIEF DESCRIPTION OF THE DRAWINGS

In the accompanying drawings:

FIG. 1 is a block diagram illustrating a configuration of an object recognition device;

FIG. 2 is a block diagram illustrating a functional configuration of the object recognition device;

FIG. 3 is a flowchart of a process performed by the object recognition device;

FIG. 4 is an explanatory diagram illustrating the process performed by the object recognition device;

FIG. 5 is an explanatory diagram illustrating a stereoscopic point condition;

FIG. 6 is an explanatory diagram illustrating a method of calculating the number of detection points.

FIG. 7 is an explanatory diagram illustrating a method of calculating a discontinuity index.

FIG. 8 is an explanatory diagram illustrating a method of calculating an irregularity index.

FIG. 9 is a flowchart of a processing of stereoscopic surface redetermination performed by the object recognition device.

FIG. 10 is a flowchart of the processing of stereoscopic surface redetermination performed by the object recognition device;

FIG. 11 is an explanatory diagram illustrating division and regeneration of a stereoscopic surface cluster; and

FIG. 12 is an explanatory diagram illustrating a method of dividing the stereoscopic surface cluster.

### DETAILED DESCRIPTION OF THE PREFERRED EMBODIMENTS

JP 2015-22541 A discloses an object recognition device. The object recognition device recognizes an object by using a laser radar or the like.

Detailed studies by the inventor found the following problems. Object recognition devices recognize an object by using detection points acquired by using a laser radar or the like. In the acquired detection points, a detection point due to a space floating object or the like may be included. In this case, it is difficult to accurately recognize the object. An aspect of the present disclosure preferably provides an object recognition device that can prevent a detection point due to a space floating object or the like from being used to recognize an object.

Explanatory embodiments of the present disclosure will be described with reference to the drawings.

### First Embodiment

1. Configuration of Object Recognition Device 1

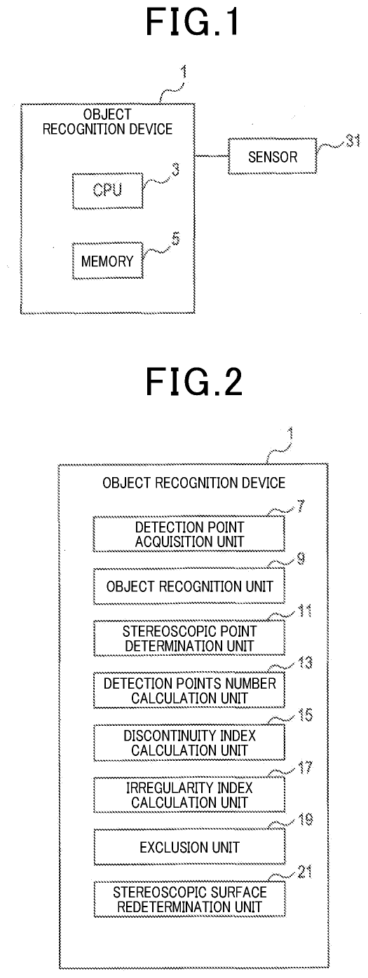

A configuration of the object recognition device 1 will be described with reference to FIG. 1 and FIG. 2. The object recognition device 1 is installed in, for example, a vehicle. The object recognition device 1 includes a microcomputer having a CPU 3 and a semiconductor memory (hereinafter, referred to as a memory 5) such as a RAM and a ROM.

Functions of the object recognition device 1 are implemented by the CPU 3 executing a program stored in a non-transitory tangible storage medium. In this example, the memory 5 corresponds to the non-transitory tangible storage medium storing the program. Executing the program implements a method corresponding to the program. The object recognition device 1 may include one microcomputer or a plurality of microcomputers.

As illustrated in FIG. 2, the object recognition device 1 includes a detection point acquisition unit 7, an object recognition unit 9, a stereoscopic point determination unit 11, a detection point number calculation unit 13, a discontinuity index calculation unit 15, an irregularity index calculation unit 17, an exclusion unit 19, and a stereoscopic surface redetermination unit 21. The stereoscopic surface redetermination unit 21 corresponds to a cluster formation unit and an invalidation unit.

As illustrated in FIG. 1, the object recognition device 1 is connected with a sensor 31. The sensor 31 is, for example, a LIDAR. The sensor 31 may be other than the LIDAR. The sensor other than the LIDAR is, for example, a camera, a millimeter-wave radar, or the like. The camera is, for example, a stereo camera, a monocular camera, or the like. The sensor 31 is installed in, for example, a vehicle. The sensor 31 detects, for example, an object present around the vehicle. The sensor 31 transmits a signal indicating a detection result to the object recognition device 1.

2. Process Performed by Object Recognition Device 1

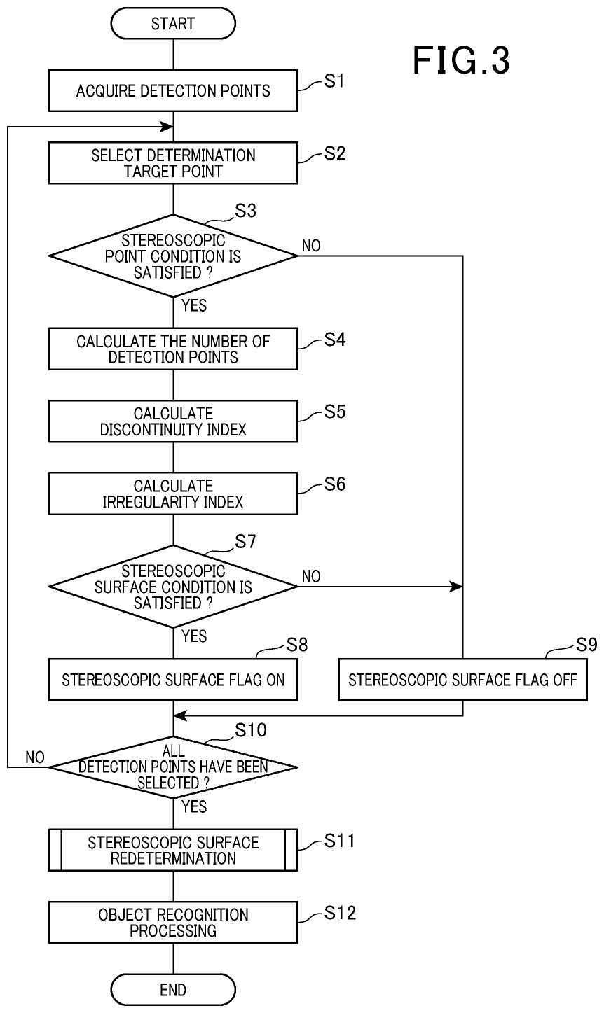

A process performed by the object recognition device 1 will be described with reference to FIG. 3 to FIG. 12. In step 1 in FIG. 3, the detection point acquisition unit 7 performs measurement by using the sensor 31 to acquire detection points 33 in a plurality of orientations. The orientation is with reference to the sensor 31. The orientation includes an orientation in the vertical direction (hereinafter, referred to as a vertical direction orientation) and an orientation in the horizontal direction (hereinafter, referred to as a horizontal direction orientation 42). Each of the detection points 33 has the vertical direction orientation and the horizontal direction orientation 42.

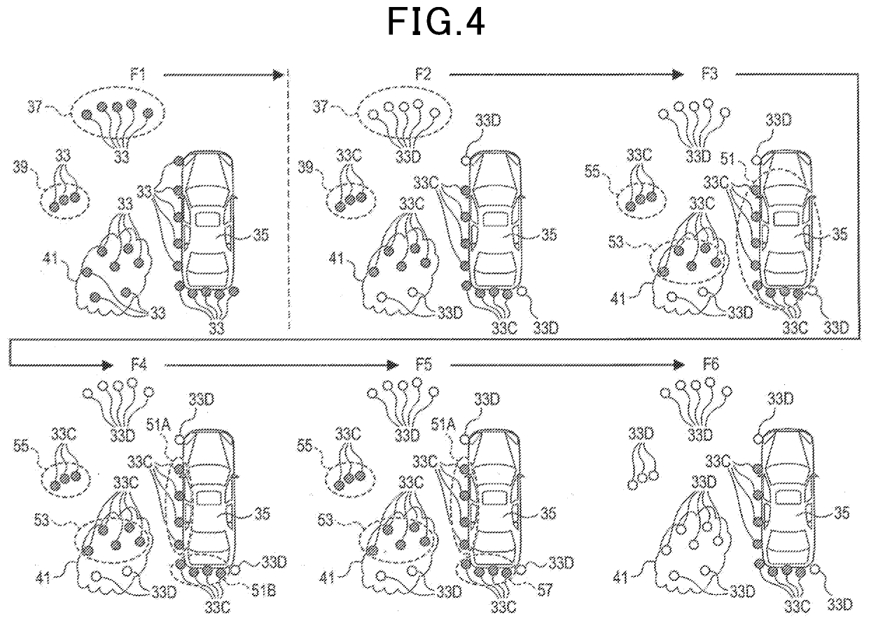

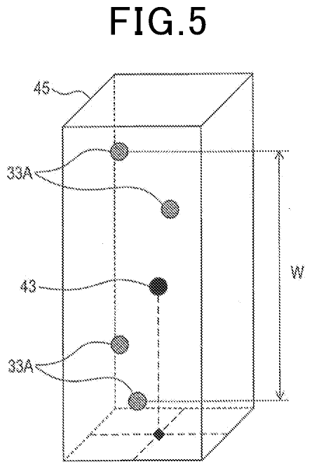

F1 in FIG. 4 illustrates an example of the acquired detection points 33. The detection points 33 can be acquired by reflection from, for example, a peripheral vehicle 35, a road surface 37, a roadside object 39, or a space floating object 41. The space floating object 41 is, for example, a minute particle included in exhaust gas.

In step 2, the exclusion unit 19 selects one detection point 33 from the detection points 33 acquired in the step 1. The selected detection point 33 is hereinafter referred to as a determination target point 43. The processing of step 2 is repeated until an affirmative determination is made in step 10 described later. The detection point 33 selected by the exclusion unit 19 has not yet been selected as the determination target point 43 in the processing of the past step 2.

In step 3, the stereoscopic point determination unit 11 determines whether the determination target point 43 selected in the last step 2 satisfies a stereoscopic point condition. The stereoscopic point condition will be described with reference to FIG. 5. The stereoscopic point determination unit 11 sets a region 45 including the determination target point 43.

The region 45 has given widths in the vertical direction and the horizontal direction. The stereoscopic point determination unit 11 specifies detection points 33 (hereinafter, referred to as an in-region detection points 33A) other than the determination target point 43. The stereoscopic point determination unit 11 calculates the number X of the in-region detection points 33A having a vertical direction orientation different from that of the determination target point 43. The stereoscopic point condition is that, for example, X is a predetermined threshold value or larger.

The stereoscopic point condition may be that a height W is a predetermined threshold value or higher. The height W is a distance in the vertical direction between the highest one of the in-region detection points 33A and the lowest one of the in-region detection points 33A.

The stereoscopic point condition corresponds to a state in which other detection points 33 having heights different from that of the determination target point 43 are present in the region 45. If the stereoscopic point condition is satisfied, the present process proceeds to step 4. If the stereoscopic point condition is not satisfied, the present process proceeds to step 9.

The processing in step 3 is repeated until an affirmative determination is made in step 10 described later. The determination target points 43 to be processed in processing of respective steps 3 are different from each other. Hence, the stereoscopic point determination unit 11 determines whether each of the plurality of detection points 33 acquired in the step 1 satisfies the stereoscopic point condition.

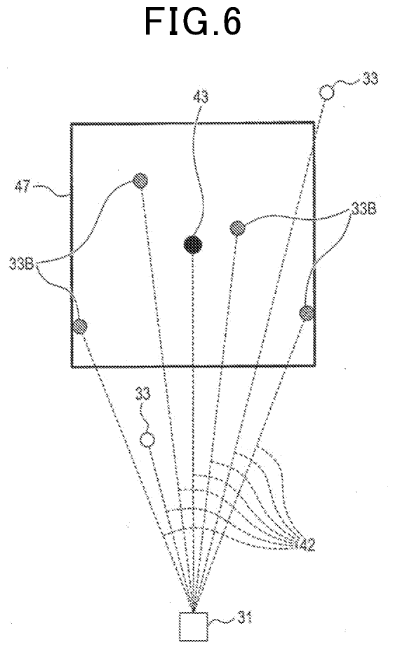

In step 4, the detection point number calculation unit 13 calculates the number of detection points of the determination target point 43 selected in the processing of the last step 2. A method of calculating the number of detection points will be described with reference to FIG. 6. The detection point number calculation unit 13 sets a region 47 including the determination target point 43. The region 47 has a given width in the vertical direction. When viewed in the vertical direction, the region 47 has, for example, a rectangular shape. The determination target point 43 is located, for example, at the center of the region 47.

The detection point number calculation unit 13 specifies the detection point 33 (hereinafter, referred to as an in-region detection point 33B) whose vertical direction orientation is the same as that of the determination target point 43 and whose coordinate in the horizontal direction is present in the region 47. The detection point number calculation unit 13 sets the number of the in-region detection points 33B as the detection point number.

The processing in step 4 is repeated until an affirmative determination is made in step 10 described later. The determination target points 43 to be processed in processing of respective steps 4 are different from each other. Hence, the detection point number calculation unit 13 calculates the detection point number for each of the plurality of detection points 33.

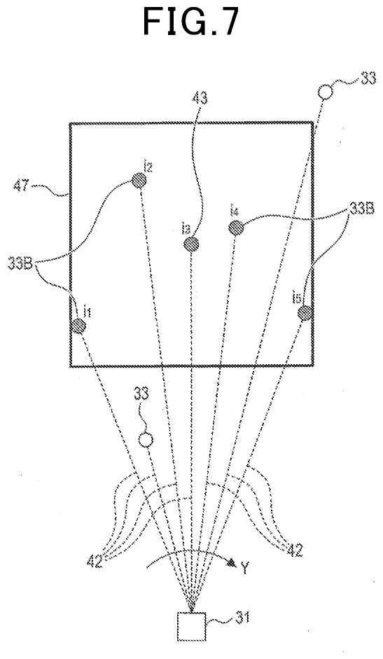

In step 5, the discontinuity index calculation unit 15 calculates a discontinuity index D of the determination target point 43 selected in the last step 2. A method of calculating the discontinuity index D will be described with reference to FIG. 7. The discontinuity index calculation unit 15 uses the in-region detection point 33B calculated in the processing of the step 4.

The discontinuity index calculation unit 15 extracts orientation numbers of the determination target point 43 and the in-region detection point 33B. The orientation numbers are numbers denoting all of the horizontal direction orientations 42 in which the sensor 31 radiates electromagnetic waves. As the horizontal direction orientation 42 changes in a given direction Y, the orientation number becomes high. The difference Δd between an arbitrary orientation number and the orientation number adjacent thereto is constant.

In the example illustrated in FIG. 7, the extracted orientation numbers are i₁, i₂, i₃, i₄, and i₅. Between i₁ and i₂, one orientation number of the detection point 33B, which is not present in the region 47, is present. Hence, the difference between i₁ and i₂ is 2Δd. Between i₄ and i₅, one orientation number of the detection point 33B, which is not present in the region 47, is present. Hence, the difference between i₄ and i₅ is 2Δd.

Between i₂ and i₃, no orientation number that is not extracted is present. Hence, the difference between i₂ and i₃ is Δd. Between i₃ and i₄, no orientation number that is not extracted is present. Hence, the difference between i₃ and i₄ is Δd. The discontinuity index calculation unit 15 calculates the discontinuity index D by the expression (1).

$$D = \frac{{\sum }_{s} sign ( {i}_{n + 1} - {i}_{n} - {m}_{( n , n + 1 )} - γ )}{N - 1} \qquad Expression ( 1 )$$

In the case illustrated in FIG. 7, n is a natural number of 1 to 4. N is the sum of the number of the in-region detection points 33B and the number of the determination target points 43. In the case illustrated in FIG. 7, N is 5. m_{(n, n+1)} is α*Δd. α is the number of the orientation numbers of unobserved points present between iₙ and iₙ₊₁. The orientation number of an unobserved point is an orientation number of the horizontal direction orientation 42 in which no detection point 33 has been acquired. γ is a threshold value, which is a constant.

The discontinuity index D becomes higher as the number of missing detection points increases. When any two in-region detection points 33B present in the region 47 are defined as a first detection point and a second detection point, the missing detection point is the detection point 33 present in the horizontal direction orientation 42 between the horizontal direction orientation 42 of the first detection point and the horizontal direction orientation 42 of the second detection point and outside the region 47. In the case illustrated in FIG. 7, the detection point 33 present in the horizontal direction orientation 42 having orientation number between i₁ and i₂ and the detection point 33 present in the horizontal direction orientation 42 having orientation number between i₄ and i₅ correspond to the missing detection points.

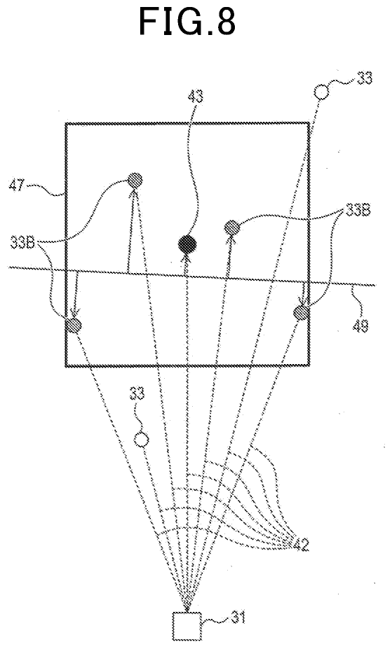

In step 6, the irregularity index calculation unit 17 calculates an irregularity index I of the determination target point 43 selected in the last step 2. A method of calculating the irregularity index I will be described with reference to FIG. 8. The irregularity index calculation unit 17 sets the region 47 as in the processing of the step 4. The irregularity index calculation unit 17 specifies the in-region detection point 33B as in the processing of the step 4.

The irregularity index calculation unit 17 calculates a regression line 49. The regression line 49 is a straight line that minimizes a regression error. The regression error is the sum of squares of a distance between the determination target point 43 and a straight line and each distance between each of the in-region detection points 33B and the straight line. The irregularity index I is a regression error when the straight line is the regression line 49. The irregularity index I is expressed by the expression (2).

$$I = {\sum }_{S} {d}_{n}^{2} \qquad Expression ( 2 )$$

dₙ is a distance between the regression line 49 and any one of the determination target point 43 and the in-region detection points 33B. The irregularity index I is higher as irregularity of the position of the in-region detection point 33B is higher.

In step 7, the exclusion unit 19 determines whether the determination target point 43 selected in the last step 2 satisfies a stereoscopic surface condition. Satisfying the stereoscopic surface condition is satisfying all the following J1 to J3.

J1: The detection point number calculated in the step 4 is larger than a predetermined threshold value.

J2: The discontinuity index D calculated in the step 5 is lower than a predetermined threshold value.

J3: The irregularity index I calculated in the step 6 is lower than a predetermined threshold value.

If the determination target point 43 selected in the last step 2 satisfies the stereoscopic surface condition, the present process proceeds to step 8. If the determination target point 43 selected in the last step 2 does not satisfy the stereoscopic surface condition, the present process proceeds to step 9.

In step 8, the exclusion unit 19 turns on a stereoscopic surface flag for the determination target point 43 selected in the last step 2.

In step 9, the exclusion unit 19 turns off the stereoscopic surface flag for the determination target point 43 selected in the last step 2.

F2 in FIG. 4 illustrates a case in which the stereoscopic surface flag is turned on or off. 33C is the detection point 33 at which the stereoscopic surface flag is in an on state. 33D is the detection point 33 at which the stereoscopic surface flag is in an off state. Compared with the detection point 33 acquired by reflection from the peripheral vehicle 35, the stereoscopic surface flag is easily turned off at the detection point 33 acquired by reflection from the road surface 37 and the detection point 33 acquired by reflection from the space floating object 41.

In step 10, the exclusion unit 19 determines whether all the detection points 33 acquired in the step 1 have been selected as the determination target point 43 in the step 2. If all the detection points 33 have been selected as the determination target point 43, the present process proceeds to step 11. If any of the detection points 33 has not been selected as the determination target point 43, the present process proceeds to step 2.

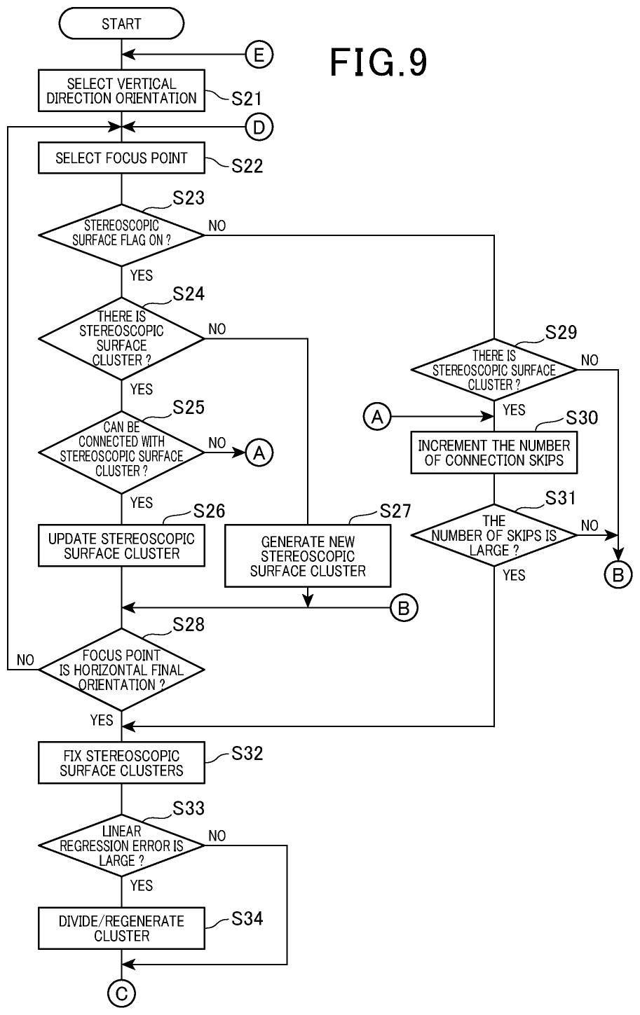

In step 11, the stereoscopic surface redetermination unit 21 performs stereoscopic surface redetermination. This processing will be described with reference to FIG. 9 to FIG. 12. In step 21 in FIG. 9, the stereoscopic surface redetermination unit 21 selects one vertical direction orientation from among the vertical direction orientations of the detection points 33 acquired in the step 1. The processing of step 21 is repeated until an affirmative determination is made in step 39 described later. The vertical direction orientation selected in the stereoscopic surface redetermination unit 21 has not yet been selected in the processing of the past step 21.

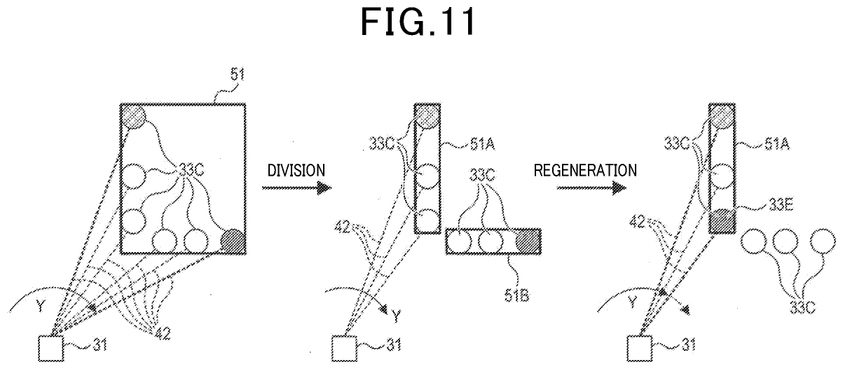

In step 22, the stereoscopic surface redetermination unit 21 selects a focus point. The focus point is one detection point 33 present in the vertical direction orientation selected in the last step 21. The processing of step 22 is repeated until an affirmative determination is made in step 39 described later. The focus point selected by the stereoscopic surface redetermination unit 21 is the detection point 33 that has not been selected in the processing of the past step 22. The stereoscopic surface redetermination unit 21 selects a focus point so that the horizontal direction orientations 42 of the sequentially selected focus points change in the direction Y illustrated in FIG. 11.

In step 23, the stereoscopic surface redetermination unit 21 determines whether the stereoscopic surface flag of the focus point selected in the last step 22 is in an on state. If the stereoscopic surface flag of the focus point is in an on state, the present process proceeds to step 24. If the stereoscopic surface flag of the focus point is in an off state, the present process proceeds to step 29.

In step 24, the stereoscopic surface redetermination unit 21 determines whether there is a stereoscopic surface cluster. The stereoscopic surface cluster is a set of the detection points 33. If there is a stereoscopic surface cluster, the present process proceeds to step 25. If there is no stereoscopic surface cluster, the present process proceeds to step 27.

In step 25, the stereoscopic surface redetermination unit 21 determines whether the focus point selected in the last step 22 and the stereoscopic surface cluster can be connected to each other. The wording “the focus point and the stereoscopic surface cluster can be connected to each other” means that a distance between the focus point and any of the detection points 33 included in the stereoscopic surface cluster is a predetermined threshold value or shorter. If the focus point and the stereoscopic surface cluster can be connected to each other, the present process proceeds to step 26. If the focus point and the stereoscopic surface cluster cannot be connected to each other, the present process proceeds to step 30.

In step 26, the stereoscopic surface redetermination unit 21 updates the stereoscopic surface cluster so as to include the focus point selected in the last step 22. The stereoscopic surface redetermination unit 21 initializes the number of connection skips of the updated stereoscopic surface cluster so as to be 0.

In step 27, the stereoscopic surface redetermination unit 21 creates a new stereoscopic surface cluster including the focus point selected in the last step 22.

In step 28, the stereoscopic surface redetermination unit 21 determines whether the horizontal direction orientation 42 of the focus point selected in the last step 22 is a horizontal final orientation. The horizontal final orientation is the most advanced horizontal direction orientation 42 in the direction Y among the horizontal direction orientations 42 of the detection points 33 present in the vertical direction orientation selected in the last step 21. If the horizontal direction orientation 42 of the focus point is the horizontal final orientation, the present process proceeds to step 32. If the horizontal direction orientation 42 of the focus point is not the horizontal final orientation, the present process proceeds to step 22.

In step 29, the stereoscopic surface redetermination unit 21 determines whether there is a stereoscopic surface cluster. If there is a stereoscopic surface cluster, the present process proceeds to step 30. If there is no stereoscopic surface cluster, the present process proceeds to step 28.

In step 30, the stereoscopic surface redetermination unit 21 increments the number of connection skips.

In step 31, the stereoscopic surface redetermination unit 21 determines whether the number of connection skips is more than a predetermined threshold value. If the number of connection skips is larger than the threshold value, the present process proceeds to step 32. If the number of connection skips is not larger than the threshold value, the present process proceeds to step 28.

In step 32, the stereoscopic surface redetermination unit 21 fixes stereoscopic surface clusters. F3 in FIG. 4 illustrates the fixed stereoscopic surface clusters 51, 53, 55.

In step 33, the stereoscopic surface redetermination unit 21 calculates a linear regression error of the stereoscopic surface cluster.

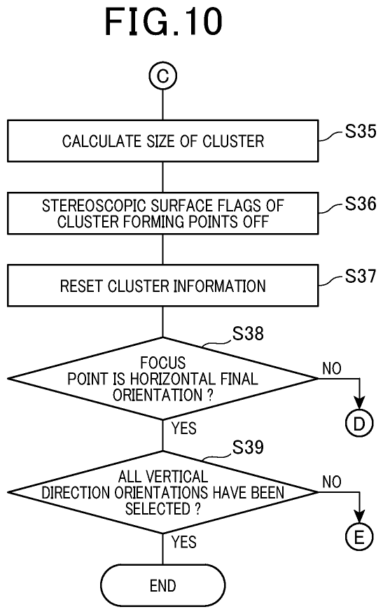

The linear regression error of the stereoscopic surface cluster is the sum of squares of each distance between the regression line and detection points 33C included in the stereoscopic surface cluster. The stereoscopic surface redetermination unit 21 determines whether the calculated linear regression error is larger than a predetermined threshold value. If the linear regression error of the stereoscopic surface cluster is larger than the threshold value, the present process proceeds to step 34. If the linear regression error of the stereoscopic surface cluster is not larger than the threshold value, the present process proceeds to step 35 in FIG. 10.

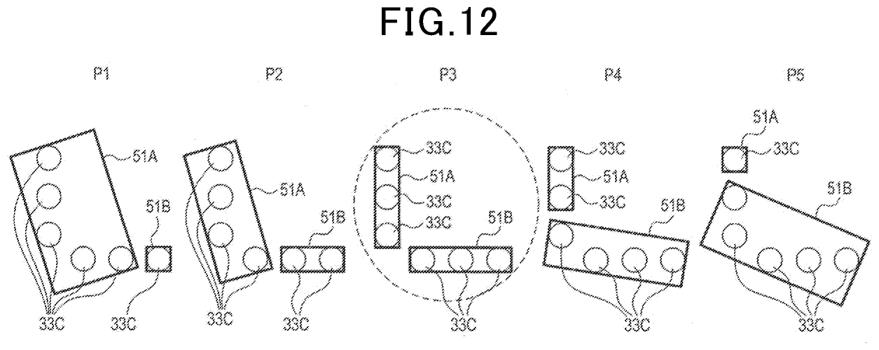

In step 34, the stereoscopic surface redetermination unit 21 divides the stereoscopic surface cluster, whose linear regression error is determined to be larger than the threshold value, into two stereoscopic surface clusters. A method of dividing the stereoscopic surface cluster will be described based on a case illustrated in FIG. 11 and FIG. 12.

The linear regression error of the stereoscopic surface cluster 51 illustrated in FIG. 11 is larger than the threshold value. As illustrated in FIG. 12, the stereoscopic surface redetermination unit 21 assumes a plurality of patterns P1 to P5 of dividing the stereoscopic surface cluster 51 into two stereoscopic surface clusters 51A, 51B.

The stereoscopic surface redetermination unit 21 calculates, for each of the patterns P1 to P5, the sum (hereinafter, referred to as a total error) of the linear regression error of the stereoscopic surface cluster 51A and the linear regression error of the stereoscopic surface cluster 51B. The stereoscopic surface redetermination unit 21 selects one pattern, whose total error is the smallest, from the patterns P1 to P5.

In the case illustrated in FIG. 11 and FIG. 12, the total error of the pattern P3 is the smallest. The stereoscopic surface redetermination unit 21 sets the stereoscopic surface clusters 51A, 51B in the pattern P3 as the divided stereoscopic surface clusters 51A, 51B. The state in which the stereoscopic surface cluster 51 is divided into the stereoscopic surface clusters 51A, 51B is illustrated in F4 in FIG. 4.

The stereoscopic surface redetermination unit 21 leaves only the divided stereoscopic surface cluster 51A whose horizontal direction orientation 42 is on the upstream side in the direction Y and deletes the divide stereoscopic surface cluster 51B. As illustrated in FIG. 11, the stereoscopic surface redetermination unit 21 sets the detection point 33C, which is included in the stereoscopic surface cluster 51A and is present in the most advanced horizontal direction orientation 42 in the direction Y, as the latest focus point 33E.

The stereoscopic surface redetermination unit 21 assumes the detection points 33C that were included in the stereoscopic surface cluster 51B has not yet been selected as a focus point. Hence, in the future processing of the step 22, the detection points 33C that were included in the stereoscopic surface cluster 51B are sequentially selected as a focus point.

For example, as illustrated in F5 in FIG. 4, at least some of the detection points 33C that was included in the stereoscopic surface cluster 51B form a new stereoscopic surface cluster 57. If a linear regression error of the new stereoscopic surface cluster 57 is larger than the threshold value, the processing of step 34 is performed for the stereoscopic surface cluster 57.

In step 35, the stereoscopic surface redetermination unit 21 calculates the size of the stereoscopic surface cluster.

In step 36, the stereoscopic surface redetermination unit 21 turns off the stereoscopic surface flags of the detection points 33C included in the stereoscopic surface cluster whose size calculated in the step 35 is a predetermined threshold value or smaller. As a result, the detection point 33C included in the stereoscopic surface cluster whose size is the threshold value or smaller changes to a detection point 33D.

The stereoscopic surface redetermination unit 21 turns off the stereoscopic surface flag of the detection point 33C included in the stereoscopic surface cluster whose linear regression error is the predetermined threshold value or larger. As a result, the detection point 33C included in the stereoscopic surface cluster whose linear regression error is the threshold value or larger changes to the detection point 33D.

When the processing in the step 34 is not performed, the linear regression error used in step 36 is the linear regression error calculated in the step 33. When the stereoscopic surface cluster is divided in the step 34, the linear regression error used in step 36 is the linear regression error of the divided stereoscopic surface cluster calculated in the step 34.

In the case illustrated in F5 in FIG. 4, the size of the stereoscopic surface cluster 55 is the threshold value or smaller. Hence, the detection point 33C included in the stereoscopic surface cluster 55 changes to the detection point 33D as illustrated in F6 of FIG. 4. Although the size of the stereoscopic surface cluster 53 is the threshold value or larger, the linear regression error of the stereoscopic surface cluster 53 is the threshold value or larger. Hence, the detection point 33C included in the stereoscopic surface cluster 53 changes to the detection point 33D as illustrated in F6 of FIG. 4.

The sizes the stereoscopic surface clusters 51A, 57 are the threshold value or larger, and the linear regression errors of the stereoscopic surface clusters 51A, 57 are smaller than the threshold value. Hence, the detection points 33C included in the stereoscopic surface clusters 51A, 57 remain the same as illustrated in F6 of FIG. 4.

In step 37, the stereoscopic surface redetermination unit 21 resets cluster information.

In step 38, the stereoscopic surface redetermination unit 21 determines whether the horizontal direction orientation 42 of the latest focus point 33E is a horizontal final orientation. If the horizontal direction orientation 42 of the latest focus point 33E is the horizontal final orientation, the present process proceeds to step 39. If the horizontal direction orientation 42 of the latest focus point 33E is not the horizontal final orientation, the present process proceeds to step 22.

In step 39, the stereoscopic surface redetermination unit 21 determines whether all the vertical direction orientations of the detection points 33 acquired in the step 1 have been selected in the step 21. If all the vertical direction orientations have been selected, the processing of the stereoscopic surface redetermination is completed, and the present process proceeds to step 21. If there is the vertical direction orientation that has not yet been selected, the present process proceeds to step 21.

Returning back to FIG. 3, in step 12, the object recognition unit 9 recognizes an object by using the detection points 33C.

3. Effects Provided by Object Recognition Device 1

(1A) The object recognition device 1 excludes the detection points 33 that do not satisfy the stereoscopic point condition, the detection points 33 the detection point number of which is a threshold value or smaller, the detection points 33 whose discontinuity index D is a threshold value or higher, and the detection points 33 whose irregularity index I is a threshold value or higher, from the detection points 33 acquired by using the sensor 31. The object recognition device 1 recognizes an object by using the detection points 33 that have not been excluded.

The detection points 33 due to the space floating object 41 are spatially distributed in a random manner. Hence, the detection points 33 due to the space floating object 41 are easily excluded. Since a group of the detection points 33 due to an object such as a body of the vehicle is distributed in a planar shape spreading in the vertical direction, the group is difficult to exclude. As a result, the object recognition device 1 can prevent the detection points 33 due to the space floating object 41 from being used for recognizing an object.

(1B) The object recognition device 1 generates a stereoscopic surface cluster by using the detection point 33C. The detection point 33C corresponds to the detection point 33 that has not been excluded by the exclusion unit 19. The object recognition device 1 turns off the stereoscopic surface flag of the detection point 33C included in the stereoscopic surface cluster whose size is a threshold value or smaller and whose linear regression error is a threshold value or larger. This processing corresponds to invalidating the detection point 33C included in the stereoscopic surface cluster corresponding to a predetermined invalid condition. The size of the stereoscopic surface cluster being the threshold value or smaller and the linear regression error of the stereoscopic surface cluster being the threshold value or larger correspond to the invalid condition.

The object recognition device 1 recognizes an object by using the detection point 33C remaining after the above processing. The detection point 33C included in the stereoscopic surface cluster whose size is the threshold value or smaller is highly likely to be the detection point 33C due to the roadside object 39 or the like. The detection point 33C included in the stereoscopic surface cluster whose linear regression error is the threshold value or larger is highly likely to be the detection point 33C due to the space floating object 41 or the like.

The object recognition device 1 can prevent the detection points 33 due to the roadside object 39 or the space floating object 41 from being used for recognizing an object.

### Other Embodiments

An embodiment of the present disclosure has been described above. However, the present disclosure is not limited to the above embodiment and can be variously modified.

(1) Satisfying the stereoscopic surface condition may be satisfying J1 and J2. Also in this case, the effects of the first embodiment can be provided. Satisfying the stereoscopic surface condition may be satisfying J1 and J3. Also in this case, the effects of the first embodiment can be provided.

(2) The object recognition device 1 may not perform the processing of the stereoscopic surface redetermination in the step 11. In this case, the object recognition device 1 can perform the object recognition processing in the step 12 by using, for example, the detection point 33C at the time when an affirmative determination is made in the step 10. Even when not performing the processing of the stereoscopic surface redetermination in the step 11, the object recognition device 1 can provide the effect (1A) of the first embodiment.

(3) The target recognition device 1 and the method thereof disclosed in the present disclosure may be realized by a dedicated computer that is configured to include a memory and a processor programmed to execute one or a plurality of functions embodied by a computer program. Alternatively, the target recognition device 1 and the method thereof disclosed in the present disclosure may be realized by a dedicated computer configured to include a processor consisting of one or more dedicated hardware logic circuits. Alternatively, the target recognition device 1 and the method thereof disclosed in the present disclosure may be realized by one or more dedicated computers configured by a combination of a memory and a processor programmed to execute one or a plurality of functions, with a processor consisting of one or more hardware logic circuits. The computer program may be stored in a computer-readable non-transitory tangible storage medium as instructions executed by a computer. The method realizing functions of parts included in the target recognition device 1 may not necessarily include software. All the functions may be realized by one or a plurality of hardware components.

(4) A plurality of functions of a single component of the above embodiments may be realized by a plurality of components. One function of one component may be realized by a plurality of components. A plurality of functions of a plurality of components may be realized by a single component. One function realized by a plurality of components may be realized by a single component. Furthermore, part of the configuration of the above embodiments may be omitted. Furthermore, at least part of the configuration of the above embodiments may be added to or replaced by another part of the configuration of the embodiments.

(5) The present disclosure may be realized by, in addition to the target recognition device 1 described above, various forms such as a system including the target recognition device 1 as a component, a program for causing a computer to function as the target recognition device 1, a non-transitory tangible recording medium such as a semiconductor memory storing the program, and a target recognition method.

(1) An aspect of the present disclosure is an object recognition device (1) including: a detection point acquisition unit (7) configured to acquire detection points (33) in a plurality of orientations by using a sensor (31); and an object recognition unit (9) configured to recognize an object by using at least some of the detection points acquired by the detection point acquisition unit.

The object recognition device, which is an aspect of the present disclosure, includes a stereoscopic point determination unit (11) configured to determine whether each of the plurality of detection points satisfies a stereoscopic point condition defined below; a detection point number calculation unit (13) configured to calculate a detection point number defined below for each of the plurality of detection points; a discontinuity index calculation unit (15) configured to calculate a discontinuity index that becomes higher as the number of missing detection points defined below increases, for each of the plurality of detection points; and an exclusion unit (19) configured to exclude the detection point that does not satisfy the stereoscopic point condition, the detection point the detection point number of which is a threshold value or smaller, and the detection point the discontinuity index of which is a threshold value or higher, from the detection points acquired by the detection point acquisition unit.

The object recognition unit is configured to recognize the object by using the detection point that is acquired by the detection point number calculation unit and has not been excluded by the exclusion unit.

The stereoscopic point condition: another detection point having a different height is present in a predetermined region (45) including the detection point (43) for which whether to satisfy the stereoscopic point condition is determined.

The detection point number: the number of the detection points present in a predetermined region (47) including the detection point (43) for which the detection point number is calculated.

The missing detection point: the detection point present in the orientation between the orientation of a first detection point and the orientation of a second detection point and outside a predetermined reference region (47), the first and second detection points being any two of the detection points present in the reference region (47) including the detection point (43) for which the discontinuity index is calculated.

The object recognition device, which is an aspect of the present disclosure, can prevent a detection point due to a space floating object or the like from being used to recognize an object.

(2) Another aspect of the present disclosure is an object recognition device (1) including: a detection point acquisition unit (7) configured to acquire detection points (33) in a plurality of orientations by using a sensor (31); and an object recognition unit (9) configured to recognize an object by using at least some of the detection points acquired by the detection point acquisition unit.

The object recognition device, which is another aspect of the present disclosure, includes a stereoscopic point determination unit (11) configured to determine whether each of the plurality of detection points satisfies a stereoscopic point condition defined below; a detection point number calculation unit (13) configured to calculate a detection point number defined below for each of the plurality of detection points; an irregularity index calculation unit (17) configured to calculate an irregularity index defined below for each of the plurality of detection points; and an exclusion unit (19) configured to exclude the detection point that does not satisfy the stereoscopic point condition, the detection point the detection point number of which is a threshold value or smaller, and the detection point the discontinuity index of which is a threshold value or higher, from the detection points acquired by the detection point acquisition unit.

The object recognition unit is configured to recognize the object by using the detection point that is acquired by the detection point number calculation unit and has not been excluded by the exclusion unit.

The stereoscopic point condition: another detection point having a different height is present in a predetermined region (45) including the detection point (43) for which whether to satisfy the stereoscopic point condition is determined.

The detection point number: the number of the detection points present in a predetermined region (47) including the detection point (43) for which the detection point number is calculated.

The irregularity index: an index that is higher as irregularity of a position of the detection point present in a predetermined region (47) including the detection point (43) for which the irregularity index is calculated is higher.

The object recognition device, which is another aspect of the present disclosure, can prevent a detection point due to a space floating object or the like from being used to recognize an object.

(3) Another aspect of the present disclosure is an object recognition device (1) including: a detection point acquisition unit (7) configured to acquire detection points (33) in a plurality of orientations by using a sensor (31); and an object recognition unit (9) configured to recognize an object by using at least some of the detection points acquired by the detection point acquisition unit.

The object recognition device, which is another aspect of the present disclosure, includes a stereoscopic point determination unit (11) configured to determine whether each of the plurality of detection points satisfies a stereoscopic point condition defined below; a detection point number calculation unit (13) configured to calculate a detection point number defined below for each of the plurality of detection points; a discontinuity index calculation unit (15) configured to calculate a discontinuity index that becomes higher as the number of missing detection points defined below increases, for each of the plurality of detection points; an irregularity index calculation unit (17) configured to calculate an irregularity index defined below for each of the plurality of detection points; and an exclusion unit (19) configured to exclude the detection point that does not satisfy the stereoscopic point condition, the detection point the detection point number of which is a threshold value or smaller, the detection point the discontinuity index of which is a threshold value or higher, and the detection point the irregularity index of which is a threshold value or higher, from the detection points acquired by the detection point acquisition unit.

The object recognition unit is configured to recognize the object by using the detection point that is acquired by the detection point number calculation unit and has not been excluded by the exclusion unit.

The stereoscopic point condition: another detection point having a different height is present in a predetermined region (45) including the detection point (43) for which whether to satisfy the stereoscopic point condition is determined.

The detection point number: the number of the detection points present in a predetermined region (47) including the detection point (43) for which the detection point number is calculated.

The missing detection point: the detection point present in the orientation between the orientation of a first detection point and the orientation of a second detection point and outside a predetermined reference region (47), the first and second detection points being any two of the detection points present in the reference region (47) including the detection point (43) for which the discontinuity index is calculated.

The irregularity index: an index that is higher as irregularity of a position of the detection point present in a predetermined region (47) including the detection point (43) for which the irregularity index is calculated is higher.

The object recognition device, which is another aspect of the present disclosure, can prevent a detection point due to a space floating object or the like from being used to recognize an object.

What is claimed is:

1. An object recognition device including:
a detection point acquisition unit configured to acquire detection points in a plurality of orientations by using a sensor; and
an object recognition unit configured to recognize an object by using at least some of the detection points acquired by the detection point acquisition unit, the object recognition device comprising:
a stereoscopic point determination unit configured to determine whether each of the plurality of detection points satisfies a stereoscopic point condition defined below;
a detection point number calculation unit configured to calculate a detection point number defined below for each of the plurality of detection points;
a discontinuity index calculation unit configured to calculate a discontinuity index that becomes higher as the number of missing detection points defined below increases, for each of the plurality of detection points; and
an exclusion unit configured to exclude the detection point that does not satisfy the stereoscopic point condition, the detection point the detection point number of which is a threshold value or smaller, and the detection point the discontinuity index of which is a threshold value or higher, from the detection points acquired by the detection point acquisition unit, wherein
the object recognition unit is configured to recognize the object by using the detection point that is acquired by the detection point number calculation unit and has not been excluded by the exclusion unit,
the stereoscopic point condition: another detection point having a different height is present in a predetermined region including the detection point for which whether to satisfy the stereoscopic point condition is determined,
the detection point number: the number of the detection points present in a predetermined region including the detection point for which the detection point number is calculated,
the missing detection point: the detection point present in the orientation between the orientation of a first detection point and the orientation of a second detection point and outside a predetermined reference region, the first and second detection points being any two of the detection points present in the reference region including the detection point for which the discontinuity index is calculated.

2. An object recognition device including:
a detection point acquisition unit configured to acquire detection points in a plurality of orientations by using a sensor; and
an object recognition unit configured to recognize an object by using at least some of the detection points acquired by the detection point acquisition unit, the object recognition device comprising:
a stereoscopic point determination unit configured to determine whether each of the plurality of detection points satisfies a stereoscopic point condition defined below;
a detection point number calculation unit configured to calculate a detection point number defined below for each of the plurality of detection points;
an irregularity index calculation unit configured to calculate an irregularity index defined below for each of the plurality of detection points; and
an exclusion unit configured to exclude the detection point that does not satisfy the stereoscopic point condition, the detection point the detection point number of which is a threshold value or smaller, and the detection point the discontinuity index of which is a threshold value or higher, from the detection points acquired by the detection point acquisition unit, wherein
the object recognition unit is configured to recognize the object by using the detection point that is acquired by the detection point number calculation unit and has not been excluded by the exclusion unit,
the stereoscopic point condition: another detection point having a different height is present in a predetermined region including the detection point for which whether to satisfy the stereoscopic point condition is determined,
the detection point number: the number of the detection points present in a predetermined region including the detection point for which the detection point number is calculated,
the irregularity index: an index that is higher as irregularity of a position of the detection point present in a predetermined region including the detection point for which the irregularity index is calculated is higher.

3. An object recognition device including:
a detection point acquisition unit configured to acquire detection points in a plurality of orientations by using a sensor; and
an object recognition unit configured to recognize an object by using at least some of the detection points acquired by the detection point acquisition unit, the object recognition device comprising:
a stereoscopic point determination unit configured to determine whether each of the plurality of detection points satisfies a stereoscopic point condition defined below;
a detection point number calculation unit configured to calculate a detection point number defined below for each of the plurality of detection points;
a discontinuity index calculation unit configured to calculate a discontinuity index that becomes higher as the number of missing detection points defined below increases, for each of the plurality of detection points;
an irregularity index calculation unit configured to calculate an irregularity index defined below for each of the plurality of detection points; and
an exclusion unit configured to exclude the detection point that does not satisfy the stereoscopic point condition, the detection point the detection point number of which is a threshold value or smaller, the detection point the discontinuity index of which is a threshold value or higher, and the detection point the irregularity index of which is a threshold value or higher, from the detection points acquired by the detection point acquisition unit, wherein
the object recognition unit is configured to recognize the object by using the detection point that is acquired by the detection point number calculation unit and has not been excluded by the exclusion unit,
the stereoscopic point condition: another detection point having a different height is present in a predetermined region including the detection point for which whether to satisfy the stereoscopic point condition is determined,
the detection point number: the number of the detection points present in a predetermined region including the detection point for which the detection point number is calculated,
the missing detection point: the detection point present in the orientation between the orientation of a first detection point and the orientation of a second detection point and outside a predetermined reference region, the first and second detection points being any two of the detection points present in the reference region including the detection point for which the discontinuity index is calculated, and
the irregularity index: an index that is higher as irregularity of a position of the detection point present in a predetermined region including the detection point for which the irregularity index is calculated is higher.

4. The object recognition device according to claim 1, further comprising:
a cluster formation unit configured to form a cluster by using the detection point that is acquired by the detection point acquisition unit and has not been excluded by the exclusion unit; and
an invalidation unit that invalidates the detection point included in the cluster corresponding to a predetermined invalid condition, wherein
the object recognition unit is configured to recognize the object by using the detection point that is acquired by the detection point acquisition unit, and has not been excluded by the exclusion unit and not been invalidated by the invalidation unit.
